(19) United States
(12) Patent Application Publication
(10) Pub. No.: US 2026/0086352 A1
(43) Pub. Date: Mar. 26, 2026

(54) OPTICAL MODULE

(71) Applicant: TDK TAIWAN CORP., Taoyuan City (TW)

(72) Inventors: Yi-Ho CHEN, Taoyuan City (TW); Yu-Chi KUO, Taoyuan City (TW)

(21) Appl. No.: 19/336,804

(22) Filed: Sep. 23, 2025

Related U.S. Application Data
(60) Provisional application No. 63/698,172, filed on Sep. 24, 2024.

(51) Int. Cl. G02B 27/00; G02B 7/02

(52) U.S. Cl. CPC G02B 27/0006; G02B 7/02

(57) ABSTRACT

An optical module includes a housing, an optical element, and a driving assembly. The housing has a hollow main body and a top wall, wherein the top wall forms an opening. The optical element is disposed on the top wall, and its location corresponds to the opening. The driving assembly is connected to the housing. The driving assembly drives the effective optical area of the optical element to move back and forth repeatedly with respect to the housing.

### CROSS REFERENCE TO RELATED APPLICATIONS

This application claims the benefit of U.S. Provisional Application No. 63/698,172, filed September 24, 2024, the entirety of which is incorporated by reference herein.

### BACKGROUND OF THE INVENTION

### FIELD OF THE INVENTION

The present invention relates to an optical module, and, in particular, it relates to an optical module having a housing and an optical element that is movable relative to the housing.

### DESCRIPTION OF THE RELATED ART

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

However, the image quality of the camera module can be affected by water droplets and dust that can may stick to the cover glass of the camera module in these electronic devices. It has become a challenge to address these problems.

### BRIEF SUMMARY OF THE INVENTION

An embodiment of the present invention provides an optical module that includes a housing, an optical element, and a driving assembly. The housing has a hollow main body and a top wall, wherein the top wall forms an opening. The optical element is disposed on the top wall, and its location corresponds to the opening. The driving assembly is connected to the housing. The driving assembly drives the effective optical area of the optical element to move back and forth repeatedly with respect to the housing.

In some embodiments, when a first signal is applied to the driving assembly, the top wall is driven by the driving assembly to move in a first reciprocating motion relative to the main body, and the effective optical area of the optical element is driven by the driving assembly to move in a second reciprocating motion relative to the top wall.

### BRIEF DESCRIPTION OF THE DRAWINGS

The present invention can be more fully understood by reading the subsequent detailed description and examples with references made to the accompanying drawings, wherein:

FIG. 1 shows an exploded view of an optical module 100 according to an embodiment of the present invention.

FIG. 2 shows an exploded view of the optical unit 10 and the base unit 20 in FIG. 1 before assembly.

FIG. 3 shows a schematic diagram of the base unit 20 connected to a controller 30 via a wire W.

FIG. 4 shows a partial cross-sectional view of the optical unit 10, the base unit 20, and the lens assembly L after assembly.

FIG. 5 shows a schematic diagram of the optical element 12 and the driving assembly 13 disposed on the opposite sides of the top wall 111.

FIG. 6 shows an enlarged view of area A in FIG. 5.

FIG. 7 shows a cross-sectional view of the optical unit 10 and the lens assembly L.

FIG. 8 shows a cross-sectional view of the lens assembly L and the optical unit 10 in an optical module 200 according to another embodiment of the present invention.

FIG. 9 shows an enlarged view of the lens assembly L connected to the bottom portion 113 of the housing 11 in FIG. 8.

### DETAILED DESCRIPTION OF THE INVENTION

The making and using of the embodiments of the optical module are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as "top," "bottom," "left," "right," "front," "back," etc., is used with reference to the orientation of the figures being described. The components of the present invention can be positioned in a number of different orientations. As such, the directional terminology is used for the purposes of illustration and is in no way limiting.

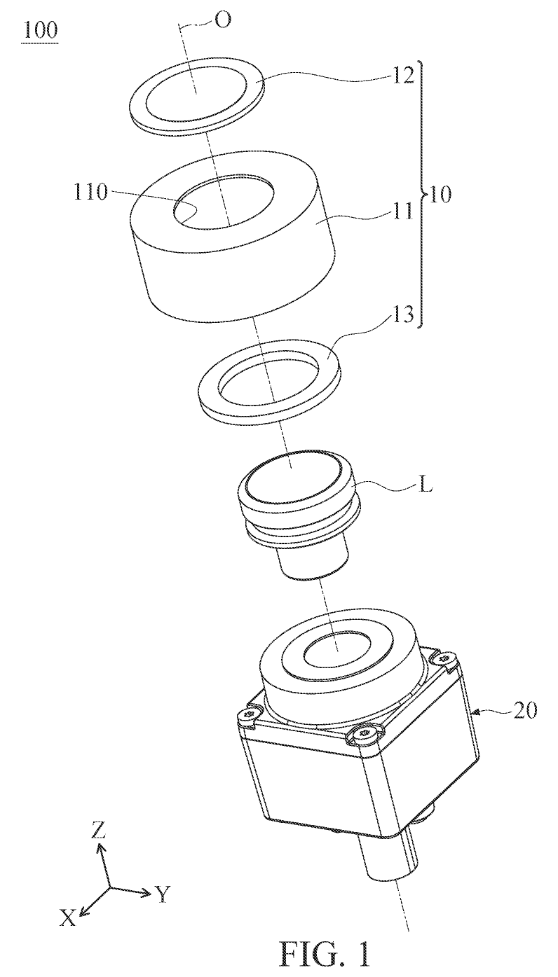

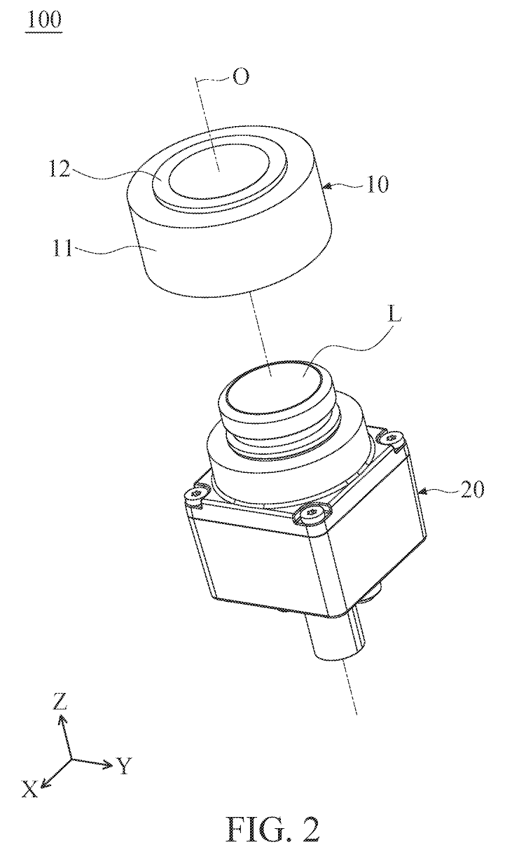

FIG. 1 shows an exploded view of an optical module 100 according to an embodiment of the present invention. FIG. 2 shows an exploded view of the optical unit 10 and the base unit 20 in FIG. 1 before assembly.

In this embodiment, the optical module 100 may be a camera module that is disposed on a vehicle or drone to capture a digital image. Referring to FIGS. 1 and 2, the optical module 100 primarily includes an optical unit 10, a base unit 20, and a lens assembly L that are connected to each other.

The optical unit 10 comprises a housing 11, an optical element 12, and an annular driving assembly 13. The optical element 12 may be a transparent cover lens that comprise plastic or glass. Specifically, the optical element 12 is disposed on the top side of the housing 11 to cover an opening 110 at the center of the housing 11. The driving assembly 13 may comprise a piezoelectric actuator that is disposed on the inner surface of the housing 11. In this embodiment, the driving assembly 13 can drive the optical element 12 to move back and forth repeatedly in a reciprocating motion, thereby cleaning and removing water droplets or dust on the surface of the optical element 12.

In this embodiment, the lens assembly L is connected to the base unit 20, and an image sensor (not shown) is provided inside the base unit 20. External light can propagate through the optical element 12 along the optical axis O of the lens assembly L and enters the optical module 100 in the -Z direction. Subsequently, light can pass through the lens assembly L and reach the image sensor of the base unit 20 to generate a digital image.

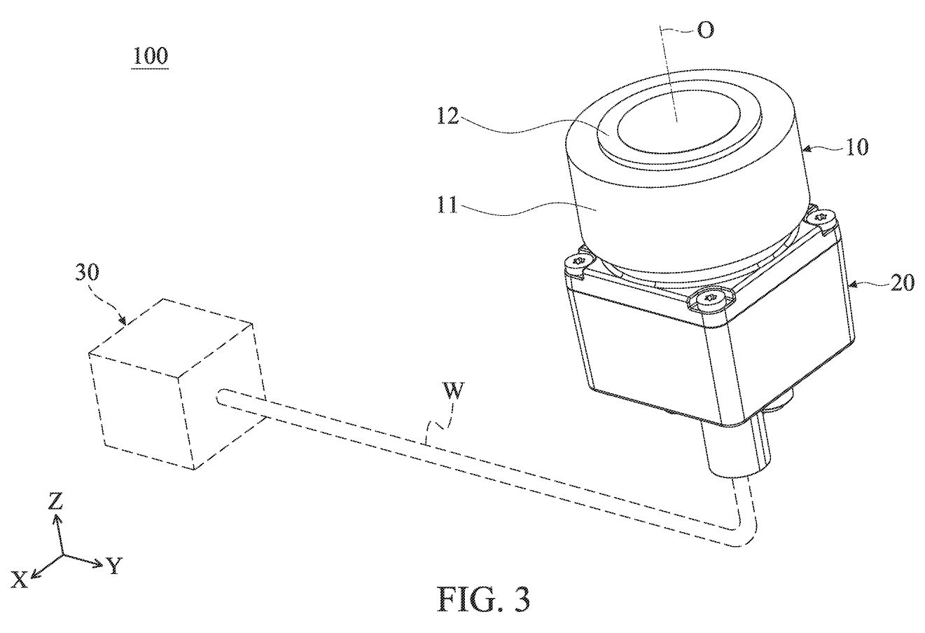

FIG. 3 shows a schematic diagram of the base unit 20 connected to a controller 30 via a wire W.

Referring to FIG. 3, the optical module 100 further includes a control unit 30 (e.g. control circuit or central controller). Specifically, the driving assembly 13 of the optical unit 10 and the image sensor of the base unit 20 are electrically connected to the control unit 30 via a wire W.

It should be noted that the control unit 30 can transmit different signals to the driving assembly 13 of the optical unit 10. The optical element 12 can be driven by the driving assembly 13 to vibrate or move in a reciprocating motion with different frequencies and/or amplitudes relative to the housing 11. Therefore, water droplets or dust can be quickly and effectively removed from the surface of the optical element 12, and the optical module 100 can be ensured to provide good image quality.

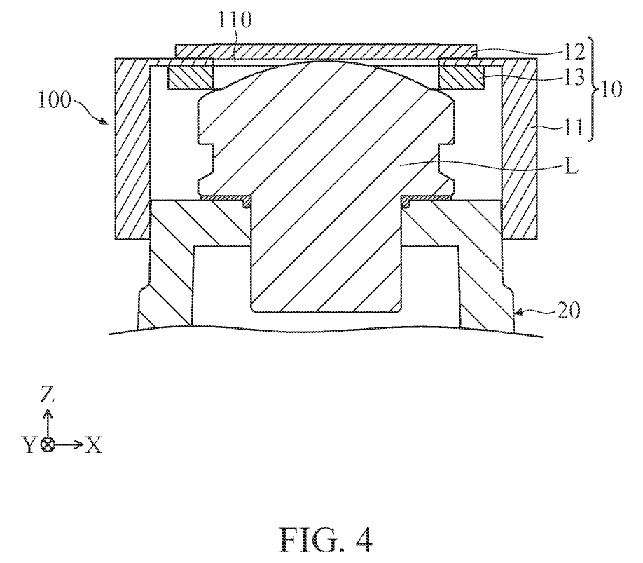

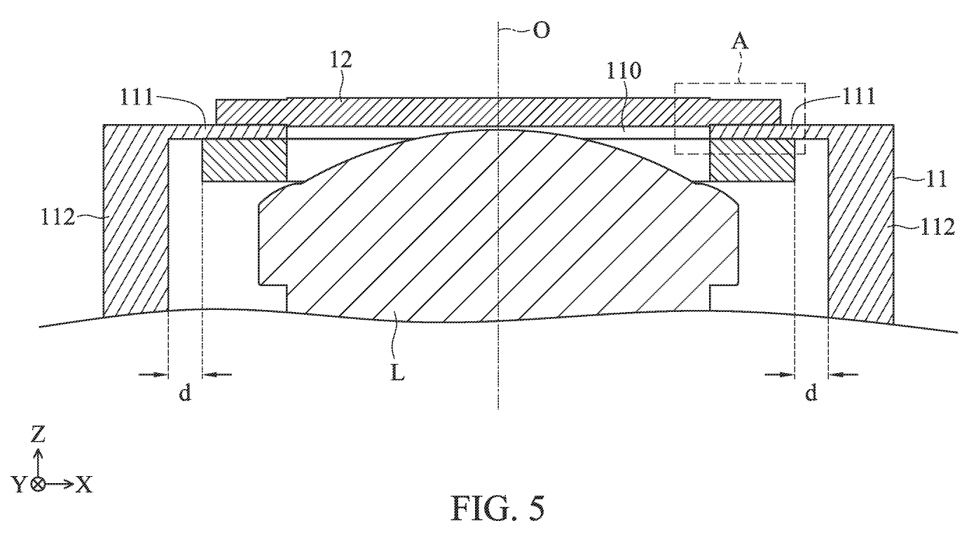

FIG. 4 shows a partial cross-sectional view of the optical unit 10, the base unit 20, and the lens assembly L after assembly. FIG. 5 shows a schematic diagram of the optical element 12 and the driving assembly 13 disposed on the opposite sides of the top wall 111.

As shown in FIG. 4, after assembly of the optical module 100, a part of the base unit 20 extends into the housing 11 of the optical unit 10, and the outer surface of the base unit 20 is affixed to the inner surface of the housing 11.

Furthermore, as shown in FIG. 5, the housing 11 of the optical unit 10 includes a top wall 111 and a hollow main body 112 connected to each other, wherein the main body 112 has a cylindrical structure. The top wall 111 is perpendicular to the optical axis O of the lens assembly L and forms a circular opening 110, wherein the top end of the lens assembly L extends into the opening 110 after assembly.

In this embodiment, the optical element 12 and the driving assembly 13 are respectively attached to the upper and lower sides of the top wall 111. Specifically, the thickness of the optical element 12 along the optical axis O (Z direction) is greater than the thickness of the top wall 111 along the optical axis O (Z direction). Moreover, the optical element 12, the driving assembly 13, and the top wall 111 at least partially overlap along the optical axis O, wherein the optical axis O is parallel to the Z axis (first axis).

Here, the driving assembly 13 is spaced apart from the main body 112 of the housing 11 by a distance d in the horizontal direction (e.g. the X direction), wherein the driving assembly 13 and the main body 112 do not contact each other.

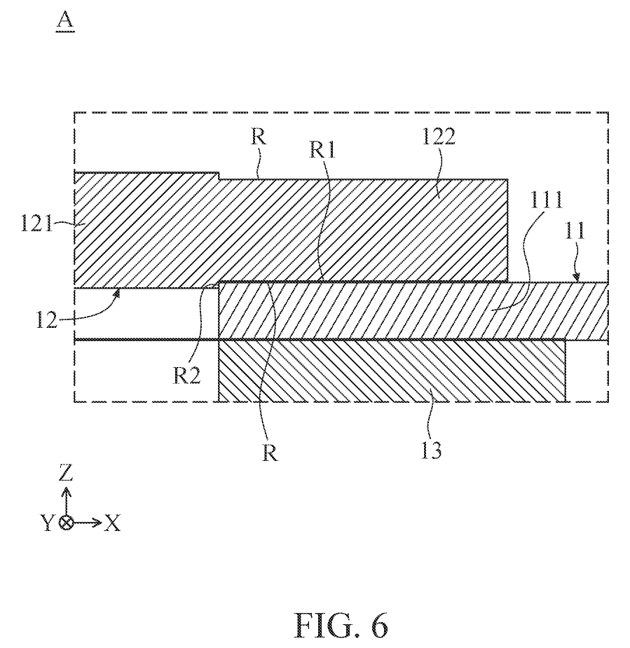

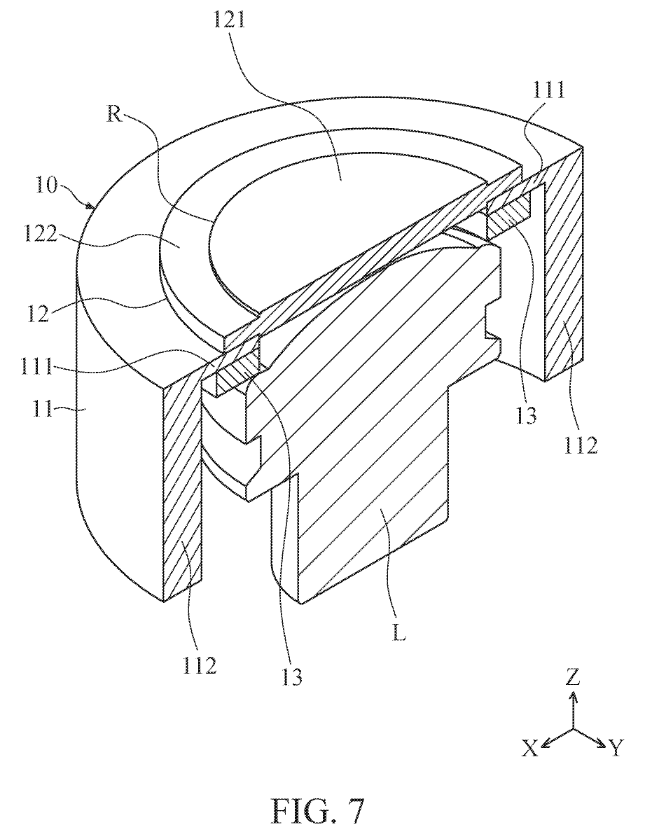

FIG. 6 shows an enlarged view of area A in FIG. 5. FIG. 7 shows a cross-sectional view of the optical unit 10 and the lens assembly L.

Referring to FIGS. 6 and 7, the optical element 12 in this embodiment has a circular optical portion 121 and an annular connecting portion 122 surrounding the optical portion 121. The optical portion 121 is configured to cover and protect the lens assembly L inside the housing 11. Moreover, the optical element 12 and the lens assembly L are spaced apart from each other by a distance along the Z axis (first axis). Specifically, the connecting portion 122 surrounds the optical portion 121 and is affixed to the top wall 111 of the housing.

As shown in FIG. 6, two recesses R are formed on the upper and lower sides of the connecting portion 122 of the optical element 12. The recess R on the bottom side of the connecting portion 122 has a first connecting surface R1 and a second connecting surface R2. During assembly, the adhesive (e.g. glue) may be disposed in the recess R to bond and secure the connecting portion 122 to the top wall 111. Here, the first and second connecting surfaces R1 and R2 are perpendicular to each other, and the thickness of the connecting portion 122 along the Z axis (first axis) is less than the thickness of the optical portion 121 along the Z axis (first axis).

In some embodiments, an elastic element (such as sheet spring or helical spring) may be used to replace the connecting portion 122, and the optical portion 121 of the optical element 12 can be connected to the upper surface of the top wall 111 through the elastic element. However, the present invention is not limited to the embodiments disclosed herein.

During operation of the optical module 100, the controller 30 (FIG. 3) can transmit a first signal at a first frequency to the driving assembly, whereby the driving assembly 13 (e.g. piezoelectric actuator) drives the top wall 111 to vibrate or move in a first reciprocating motion relative to the main body 112. Therefore, the effective optical area within the optical portion 121 at the center of the optical element 12 can be driven to move along with the first reciprocating motion of the top wall 111 and perform a second reciprocating motion relative to the top wall 111. Here, the first reciprocating motion has a first amplitude along the Z axis (first axis), the second reciprocating motion has a second amplitude along the Z axis (first axis), and the first amplitude is different from the second amplitude.

It should be noted that the first frequency is between 40KHz and 60KHz (e.g. 50KHz), whereby a wide range of area on the surface of the optical element 12 vibrates to evenly clean and remove water droplets or dust from the optical element 12.

After completing the above-mentioned procedure, the controller 30 can transmit a second signal at a second frequency to the driving assembly 13, whereby the driving assembly 13 (e.g. piezoelectric actuator) drives the top wall 111 to vibrate or move in a third reciprocating motion relative to the main body 112. Therefore, the effective optical area within the optical portion 121 at the center of the optical element 12 can be driven to move along with the third reciprocating motion of the top wall 111 and perform a fourth reciprocating motion relative to the top wall 111 Here, the third reciprocating motion has a third amplitude along the Z axis (first axis), the fourth reciprocating motion has a fourth amplitude along the Z axis (first axis), and the third amplitude is different from the fourth amplitude.

It should be noted that the second frequency is between 70KHz and 90KHz (e.g. 80KHz), thus generating a smaller but more concentrated vibration on the surface of the optical element 12. Therefore, water droplets or dust at the center of the effective optical area of the optical element 12 can be cleaned and removed more effectively. Here, the difference between the first and second amplitudes is smaller than the difference between the third and fourth amplitudes.

In some embodiments, the control unit 30 may alternate between transmitting the first signal and transmitting the second signal to the driving assembly 13, whereby the optical element 12 generates a large range (with more uniform intensity) and a small range (with more concentrated intensity) of vibration by turns. Therefore, water droplets or dust on the optical element 12 can be rapidly and effectively removed.

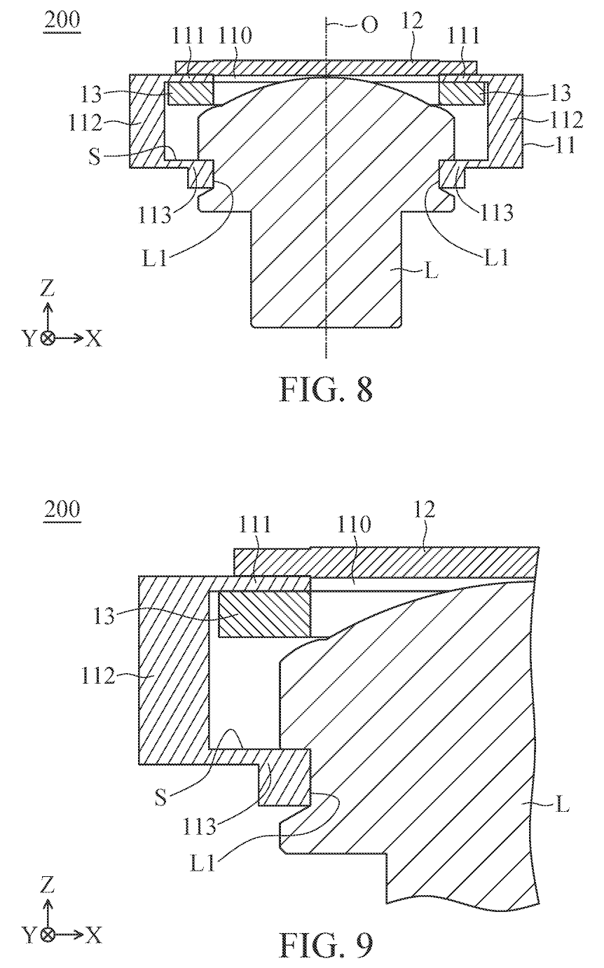

FIG. 8 shows a cross-sectional view of the lens assembly L and the optical unit 10 in an optical module 200 according to another embodiment of the present invention. FIG. 9 shows an enlarged view of the lens assembly L connected to the bottom portion 113 of the housing 11 in FIG. 8.

The optical module 200 is different from the optical module 100 of FIGS. 1 to 7 in that the housing 11 of the optical unit 10 of FIGS. 8 and 9 has a bottom portion 113, wherein the main body 112 of the housing 11 is connected between the top wall 111 and the bottom portion 113, the bottom portion 113 forms a surface S facing the top wall 111, and the lens assembly L is affixed to the surface S.

Specifically, the bottom portion 113 of the housing 11 is joined in a recess L1 of the optical unit 10, thereby increasing the connection strength between the lens assembly L and the housing 11 and improving the reliability of the optical module 200. Moreover, the overall weight and volume of the optical module 200 can be effectively reduced, thereby achieving miniaturization of the product.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical system, comprising:
a housing, having a hollow main body and a top wall, wherein the top wall forms an opening;
an optical element, disposed on the top wall, wherein the location of the optical element corresponds to the opening; and
a driving assembly, connected to the housing and driving an effective optical area of the optical element to move back and forth repeatedly with respect to the housing.

2. The optical module as claimed in claim 1, wherein when a first signal is applied to the driving assembly, the top wall is driven by the driving assembly to move in a first reciprocating motion relative to the main body, and the effective optical area of the optical element is driven by the driving assembly to move in a second reciprocating motion relative to the top wall.

3. The optical module as claimed in claim 2, wherein the first reciprocating motion has a first amplitude along a first axis, and the second reciprocating motion has a second amplitude along the first axis, wherein the first axis is perpendicular to the top wall, and the first amplitude is different from the second amplitude.

4. The optical module as claimed in claim 3, wherein when a second signal is applied to the driving assembly, the top wall is driven by the driving assembly to move in a third reciprocating motion relative to the main body, and the effective optical area of the optical element is driven by the driving assembly to move in a fourth reciprocating motion relative to the top wall, wherein the third reciprocating motion has a third amplitude along the first axis, the fourth reciprocating motion has a fourth amplitude along the first axis, and the third amplitude is different from the fourth amplitude.

5. The optical module as claimed in claim 4, wherein the first signal has a first frequency, and the second signal has a second frequency different from the first frequency.

6. The optical module as claimed in claim 5, wherein the first frequency is between 40KHz and 60KHz, and the second frequency is between 70KHz and 90KHz.

7. The optical module as claimed in claim 4, wherein the difference between the first and second amplitudes is different from the difference between the third and fourth amplitudes.

8. The optical module as claimed in claim 7, wherein the difference between the first and second amplitudes is smaller than the difference between the third and fourth amplitudes.

9. The optical module as claimed in claim 4, further comprising a control unit electrically connected to the driving assembly, wherein the control unit transmits the first signal and the second signal to the driving assembly in sequence.

10. The optical module as claimed in claim 9, wherein the control unit alternates between transmitting the first signal and transmitting the second signal to the driving assembly.

11. The optical module as claimed in claim 4, wherein the thickness of the main body along the first axis is greater than the thickness of the top wall along the first axis.

12. The optical module as claimed in claim 4, wherein the optical element and the driving assembly are disposed on opposite sides of the top wall, and the optical element, the driving assembly, and the top wall at least partially overlap along the first axis.

13. The optical module as claimed in claim 4, wherein the optical element comprises a transparent cover lens, and the driving assembly comprises a piezoelectric actuator.

14. The optical module as claimed in claim 4, wherein the optical element has a circular optical portion and an annular connecting portion surrounding the optical portion, the effective optical area is located within the optical portion of the optical element, and the optical portion is connected to the top wall through the connecting portion.

15. The optical module as claimed in claim 14, wherein the thickness of the connecting portion along the first axis is different from the thickness of the optical portion along the first axis.

16. The optical module as claimed in claim 15, wherein the thickness of the connecting portion along the first axis is less than the thickness of the optical portion along the first axis.

17. The optical module as claimed in claim 15, wherein the connecting portion has a first connecting surface and a second connecting surface that are not parallel to each other, and the top wall is adhered to the first and second connecting surfaces of the connecting portion.

18. The optical module as claimed in claim 4, further comprising a lens assembly disposed in the housing, wherein the optical element comprises a transparent lens, and an optical axis of the lens assembly is parallel to the first axis and extends through the optical element.

19. The optical module as claimed in claim 18, wherein the lens assembly extends into the opening, and the optical element is spaced apart from the lens assembly by a distance along the first axis.

20. The optical module as claimed in claim 19, wherein the housing further has a bottom portion, and the main body is connected between the top wall and the bottom portion, wherein the bottom portion has a surface facing the top wall, and the lens assembly is affixed to the surface.
